(19) United States
(12) Patent Application Publication
(10) Pub. No.: US 2019/0311395 A1
(43) Pub. Date: Oct. 10, 2019

(54) ESTIMATING CLICK-THROUGH RATE

(71) Applicant: BEIJING SANKUAI ONLINE TECHNOLOGY CO., LTD, Beijing (CN)

(72) Inventor: Lingqin LIN, Beijing (CN)

(73) Assignee: BEIJING SANKUAI ONLINE TECHNOLOGY CO., LTD, Beijing (CN)

(21) Appl. No.: 16/335,928

(22) PCT Filed: Dec. 29, 2016
(86) PCT No.: PCT/CN2016/112949

§ 371 Date: Mar. 22, 2019

(30) Foreign Application Priority Data
Sep. 23, 2016 (CN) 201610848973.X

(51) Int. Cl. G06Q 30/02

(52) U.S. Cl. CPC G06Q 30/0242; G06Q 30/0277; G06Q 30/0254; G06Q 30/0247

(57) ABSTRACT

A method of estimating a click-through rate is provided. According to the method of estimating a click-through rate, a click label is set for an exposure log based on a click log, wherein the exposure log records information of a page element presented to a user; an exposure weight corresponding to the exposure log is set based on the click label of the exposure log and a context similarity of the page element; click-through rate estimation is performed based on the exposure log set with the exposure weight.

### CROSS REFERENCE TO RELATED APPLICATIONS

This application claims priority to Chinese Patent Application No, 201610848973.X entitled “METHOD AND APPARATUS FOR ESTIMATING CLICK-THROUGH RATE AND ELECTRONIC DEVICE” filed on Sep. 23, 2016, the entire content of which is incorporated herein by reference.

### TECHNICAL FIELD

The present disclosure relates to a method and an apparatus for estimating a click-through rate and an electronic device.

### BACKGROUND

With the development of the Internet and big data technology, more and more users may obtain information through the Internet. For example, a user may browse information on a website page or an application page, perform search by inputting a keyword, or screen a range of search results by setting a search condition, and so on. For any application to obtain information, after receiving a search request or a user request for opening a page, a back-end server may firstly perform the first round of simple ranking according to a search keyword or a preset ranking rule of a page, and recall TopK page elements to be presented, such as search results and push information, which satisfy a condition then, the back-end server may perform the second round of complex ranking, for example, the back-end server may estimate a click-through rate of each result to be presented and rank the results in a descending order according to the estimated click-through rates so as to output a queue of the page elements to be presented. The estimated click-through rate is important for the accuracy of the returned page elements.

The page elements presented to the user may be recorded as exposure logs, and click actions of a user on the presented page elements may be recorded as click logs. Each log corresponds to one page element. In a case that click-through rate estimation is performed according to the click log and the exposure log, for example, the click-through rate estimation is performed by training a click-through rate estimation model, input data may include a click label showing whether the log is clicked and feature data of the log.

### SUMMARY

An example of the present disclosure provides a method of estimating a click-through rate, including:
setting a click label for an exposure log according to a click log, where the exposure log records information of page elements presented to a user;
setting an exposure weight corresponding to the exposure log based on the click label of the exposure log and a context similarity of the page elements; and
performing click-through rate estimation according to the exposure log set with the exposure weight.

Correspondingly, an example of the present disclosure also provides an apparatus for estimating a click-through rate, including:
a log processing module, configured to set a click label for an exposure log according to a click log, where the exposure log records information of page elements presented to a user;
an exposure weight setting module, configured to set an exposure weight corresponding to the exposure log based on the click label of the exposure log and a context similarity of the page elements; and
a click-through rate estimating module, configured to perform click-through rate estimation according to the exposure log set with the exposure weight.

Correspondingly, an example of the present disclosure also provides an electronic device, including a non-volatile storage medium, a processor and machine executable instructions that are stored on the non-volatile storage medium and operable on the processor. When executing the machine executable instructions, the processor implements the method of estimating a click-through rate in the example of the present disclosure.

Correspondingly, an example of the present disclosure also provides a non-volatile storage medium storing instructions. The instructions are executed by the processor to implement blocks of the method in the example of the present disclosure.

According to the method of estimating a click-through rate in the example of the present disclosure, click labels are set for exposure logs according to click logs, where the exposure logs record information of page elements presented to a user; exposure weights corresponding to the exposure logs are set based on the click labels of the exposure logs and a context similarity of the page elements; click-through rate estimation is performed according to the exposure logs set with the exposure weights. In the method of estimating a click-through rate, an impact of adjacent page elements on an exposure effect is considered. The exposure weight of the exposure log is set based on the click label of the exposure log and the context similarity of page elements, and then, the exposure weight may be introduced when a click-through rate is estimated, so that the estimated click-through rate is more accurate.

### BRIEF DESCRIPTION OF THE DRAWINGS

To describe the technical solutions in an example of the present disclosure more clearly, drawings required in descriptions of the examples of the present disclosure will be briefly introduced below. It is apparent that the drawings described below are merely some examples of the present disclosure and other drawings may be obtained by those of ordinary skill in the art based on these drawings in the examples of the present disclosure without paying creative work.

FIG. 1 is a flowchart illustrating a method of estimating a click-through rate according to a first example of the present disclosure.

FIG. 2 is a flowchart illustrating a method of estimating a click-through rate according to a second example of the present disclosure.

FIG. 3A is a schematic diagram illustrating a hardware structure of an apparatus for estimating a click-through rate according to a third example of the present disclosure.

FIG. 3B is a schematic diagram illustrating a logic structure of an apparatus for estimating a click-through rate according to a third example of the present disclosure.

FIG. 4 is a schematic diagram illustrating a logic structure of an apparatus for estimating a click-through rate according to a fourth example of the present disclosure.

### DETAILED DESCRIPTION OF THE EMBODIMENTS

The technical solutions of examples of the present disclosure will be described clearly and fully below in combination with drawings in the examples of the present disclosure. It is apparent that the described examples are merely part of examples of the present disclosure rather than all examples. Other examples achieved by those of ordinary skill in the art without paying creative work shall all fall into the scope of protection of the present disclosure.

According to the description in the Background, a difference in exposure effectiveness of page elements in different context environments is not considered when the click-through rate estimation is performed. The exposure log not taking the exposure effectiveness into account cannot reflect the real click-through rate of the page element, thereby resulting in a low accuracy of estimating the click-through rate.

The page elements in the example of the present disclosure are clickable elements, such as search results and push information, presented on a website page or an application page. The method of estimating a click-through rate in the example of the present disclosure may be applied to perform a click-through rate estimation in a process that a server performs a search according to a keyword input by a user after the user inputs the keyword, and then performs ranking for search results; the method may also be applied to estimate the click-through rates of search results when the search results satisfying a screening condition are selected from the existing search results according to the screening condition input by the user; the method may also be applied to perform click-through rate estimation for information pushed on a website page or an application page. For example, to obtain information of nearby food merchants, a user may perform a search by inputting “food” as a keyword on Meituan; meanwhile, the user may also select a food channel on the homepage of Meituan, so that food merchants satisfying a condition will be presented in a list in the food channel. When screening preliminarily-ranked search results, the user may set a specific screening condition by selecting a particular channel to define a range of recalled search results without need to input a search word.

In examples of the present disclosure, the method of estimating a click-through rate will be described in detail with an example of estimating click-through rates of results of a search when the search is performed according to a keyword input by a user.

### Example 1

As shown in FIG. 1, a method of estimating a click-through rate in the present disclosure may include block TOO to block 120.

At block 100, click labels are set for exposure logs according to click logs, where the exposure logs record information of page elements presented to a user.

In this example, a solution of estimating a click-through rate will be described in detail by taking page elements as search results.

When performing a search after receiving a keyword or a screening condition input by a user, a server may record search results presented to the user as exposure logs, and record click actions on the search results presented to the user as click logs. Each search result presented to the user may be recorded as an exposure log, and a click action by the user on the search result presented to the user may be recorded as a click log. To facilitate log management and data analysis, the exposure log may include: a global identifier, a material identifier and a presenting order of a search result; the click log may include at least a global identifier and a material identifier of a search result. The global identifier of the search result may serve as a unique identifier of a search action, and with this global identifier, exposure records of a same search request may be obtained from the exposure logs and search results in the click logs may be obtained from the exposure logs.

Setting a click label for each of exposure logs according to click logs may include: obtaining exposure logs and click logs; determining the clicked exposure logs according to global identifiers and material identifiers in the exposure logs and the click logs; and setting different click labels for the clicked exposure logs and unclicked exposure logs respectively. Then, click-through rate estimation may be performed according to the exposure logs set with the click labels. The exposure logs and the click logs may both include a global identifier in a certain search and a material identifier of each search result in the search. In a specific implementation, a combination of the global identifier and the material identifier may be extracted as a key value from the exposure log, and then the click logs are traversed to match the key value with a combination of the global identifier and the material identifier in each click log and determine whether the exposure log has a user click action. If the match is successful, it indicates that the exposure log is clicked by a user and the click label of the exposure log is set to, for example, 1; if the match is unsuccessful, that is, the click log of a search result corresponding to the material identifier is not obtained from the search results identified by the global identifier, it indicates that the exposure log is not clicked by the user, and the click label of the exposure log is set to, for example, 0. Finally, the exposure logs set with the click labels are used as reference data in the click-through rate estimation.

At block 110, exposure weights corresponding to the exposure logs are set based on the click labels of the exposure logs and a context similarity of the page elements.

In an exposed search result list, a factor affecting an effective exposure value of a particular search result mainly is a similarity of the search result and context results thereof. The context results of a particular search result are search results directly and indirectly adjacent to the particular search result. The larger similarity between the particular search result and the search results directly and indirectly adjacent to the particular search result indicates that the particular search result and the search results directly and indirectly adjacent to the particular search result are more similar, user selection of the search result is more easily affected, and the effective exposure value of the search result is lower. Therefore, setting the exposure weights of the search results according to the similarity of the search results may increase an accuracy of presenting the search results, thereby improving the click-through rate.

A method of defining a similarity is not unique, and may be different under different search scenarios. Meanwhile, there are also many methods of calculating a similarity, including common methods of calculating a Euclidean distance or a Pearson similarity of two search results, and the like. The method of calculating a context similarity of search results recorded in the exposure log may be defined according to an actual business requirement. For example, the Euclidean distance of one or more text features between the search result recorded in the exposure log and the context results thereof may be calculated. A similarity impact value of a particular search result may be calculated through a context similarity of the search results in the exposure logs, and then, an exposure weight of the exposure log may be set according to the similarity impact value and the click label. The similarity impact value is used to indicate an impact level at which a search result recorded in the exposure log is affected by context results satisfying a preset condition.

When the exposure weight of the exposure log is set according to the similarity impact value and the click label: if the click label of the exposure log indicates that the search result recorded in the exposure log is clicked by the user, the exposure weight of the exposure log may be set to a high exposure weight if the click label of the exposure log indicates that the search result recorded in the exposure log is not clicked by the user, the exposure weight of the exposure log may be set to a low exposure weight. The value of the set exposure weight relates to the similarity between search results recorded in the exposure log.

At block 120, click-through rate estimation is performed according to the exposure logs set with the exposure weights.

The exposure logs may include an exposure log with a click label being 1 (i.e., a log recording a search result clicked by the user) and an exposure log with a click label being 0 (i.e., a log recording a search result not clicked by the user). The click-through rate estimation may be performed in many manners according to the exposure logs set with the exposure weights. For example, the click-through rate estimation may be performed by calculating a proportion of the number of effective clicks or by training a click-through rate estimation model.

Calculating a proportion of the number of effective clicks may include: determining the number of clicks X and the number of non-clicks Y for the search results according to the click labels in the exposure logs of the search results, and calculating the number of effective clicks Z of the search results according to the exposure weights of the search results recorded in the exposure logs, i.e., Z=a*X+b*Y, where “a” refers to an exposure weight of a clicked exposure log, and “b” refers to an exposure weight of an un-clicked exposure log.

One piece of training data may be generated respectively according to the exposure weight of each exposure log and a data feature extracted from the exposure log when a click-through rate estimation model is trained, including: generating training data corresponding to each exposure log by combining the click label and the exposure weight of the exposure log with the data feature extracted from the exposure log. One piece of training data may be generated respectively according to the click label and the exposure weight of each exposure log and the data feature extracted from the exposure log and thus a plurality of pieces of training data may be generated and a training data set that is used for training a click-through rate estimation model and formed by the plurality of pieces of training data may be obtained. Then, the click-through rate estimation model may be trained based on the plurality of pieces of training data, and the click-through rates of the search results may be estimated by using the click-through rate estimation model obtained by training.

According to the method of estimating a click-through rate provided in an example of the present disclosure, click labels may be set for exposure logs according to click logs, where the exposure logs record information of page elements presented to a user; exposure weights corresponding to the exposure logs may be set based on the click labels of the exposure logs and a context similarity of the page elements; finally, click-through rate estimation may be performed according to the exposure logs set with the exposure weights. According to the method of estimating a click-through rate, an impact of adjacent search results on an exposure effect is considered, the exposure weight of the exposure log is set based on the click label of the exposure log and the context similarity of the recorded page elements, and then, the click-through rate estimation is performed by introducing the exposure weight, so that the estimated click-through rate is more accurate.

### Example 2

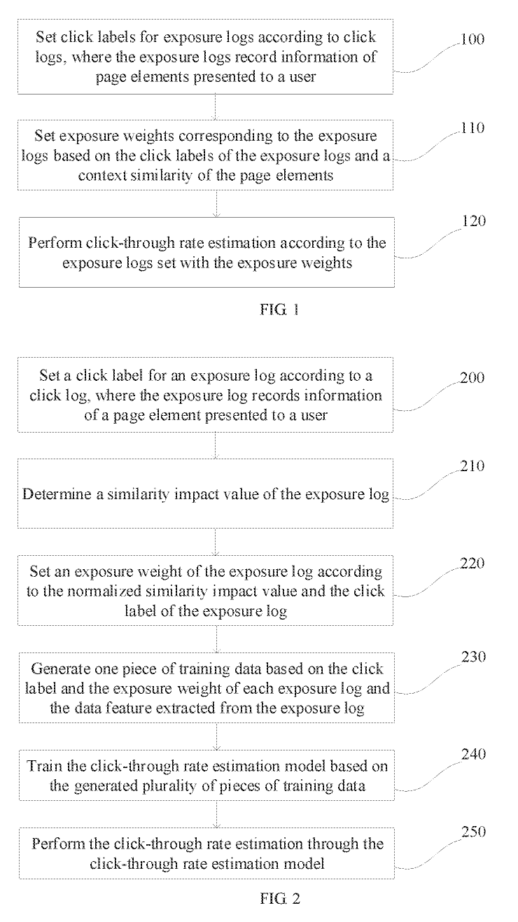

As shown in FIG. 2, a method of estimating a click-through rate in the present disclosure may include: block 200 to block 250.

In this example, a solution of estimating a click-through rate will be described in detail by taking page elements as search results.

At block 200, a click label is set for an exposure log according to a click log, where the exposure log records information of a page element presented to a user.

The example in which a click label is set for an exposure log according to a click log, where the exposure log records information of a page element presented to a user, may be implemented by referring to the relevant blocks in Example 1, which will not be described herein.

At block 210, a similarity impact value of the exposure log is determined.

The similarity impact value is used to indicate an impact level at which a page element recorded in the exposure log is affected by a context page element satisfying a preset condition.

In an exposed search result list, a factor affecting an effective exposure value of a particular search result mainly is a similarity between the particular search result and context results thereof, that is, the similarity between the particular search result and the search results directly and indirectly adjacent to the particular search result. The larger similarity between the particular search result and the search results directly and indirectly adjacent to the particular search result indicates that the particular search result and the search results directly and indirectly adjacent to the particular search result are more similar, user selection of the search result is more easily affected, and an effective exposure value of the search result is lower. Therefore, setting the exposure weights of the search results according to the similarity of the search results may increase an accuracy of presenting the search results, thereby improving a click-through rate.

In an example, determining the similarity impact value of the exposure log may include sub-blocks S1, S2 and S3.

At sub-block S1, a similarity between a page element recorded in the exposure log and each context page element satisfying a preset condition is determined respectively.

Determining the similarity between a page element recorded in the exposure log and each context page element satisfying a preset condition may include sub-blocks S11 to S14.

At sub-block S11, preset dimension attribute values of the page element recorded in the exposure log and each context page element satisfying the preset condition are determined respectively.

The context page element satisfying the preset condition includes: a page element having a difference of the presenting order of the page element and that of the page element recorded in the exposure log being less than a preset order; or a page element having a difference of the presenting order of the page element and that of the page element recorded in the exposure log being less than the preset order and having a same category attribute as the page element recorded in the exposure log. The satisfied preset condition may include that: a distance between presenting orders of two search results is less than a preset order value. According to different business scenarios to which the method of estimating a click-through rate is applied, the satisfied preset condition may also include other preset conditions. For example, when the search results returned from a search are in a merchant list, a merchant category may be used as a preset condition. A similarity between merchants can be calculated only when two merchants belong to a same category. That is, the satisfied preset condition may include that: two search results have a same category attribute, and the distance between the presenting orders of two search results is less than the preset order value. The preset order value may be 1 or 2.

A process of determining context results satisfying the preset condition will be described by taking search results as A, B, C, D, E and F and presenting orders as 1, 2, 3, 4, 5 and 6 respectively in a search. If the preset order value is equal to 1, the context result of A satisfying the preset condition is B and the context search result of B satisfying the preset condition is A and C. If the preset order value is equal to 2, the context result of A satisfying the preset condition is B and C; the context result of B satisfying the preset condition is A, C and D. If S refers to a similarity between two search results and the preset order value is equal to 2, it is only desired to calculate S_{ab} (similarity between A and B) and S_{ac} (similarity between A and C) when a similarity impact of the adjacent results for the search result A is calculated; it is only desired to calculate S_{ab} (similarity between A and B), S_{bc} (similarity between B and C) and S_{bd} (similarity between B and D) when a similarity impact of the adjacent results for the search result B is calculated. In a search scenario of a mobile terminal, a small preset order value may be set for a presenting order since the number of search results presented on a same screen is limited; however, in a search scenario of a personal computer, a large preset order value, for example, 3, may be set for the presenting order since the number of search results presented on the same screen is large.

A method of defining a similarity is not unique, and may be different under different search scenarios. Meanwhile, there are also many methods of calculating a similarity, for example, the similarity may be calculated according to a similarity distance of two groups of features obtained by calculating a Euclidean distance of the two groups of features. In an example of the present disclosure, for an application scenario of the method of estimating a click-through rate, the similarity between the search results may be calculated by selecting the attributes of typical parts presented to a user from the search results in a specific search service. Taking search for food group purchase as an example, the attribute capable of reflecting a similarity between two merchants includes a merchant title text, whether two merchants belong to a same business area, whether both merchants support group purchase; a price per person, a score, and the like. Therefore, the values of the attributes such as the merchant title text, the business area, whether group purchase is supported, a price per person, and a score may be used as preset dimension attribute values, and the preset dimension attribute values of the search result recorded in the exposure log and each context search result satisfying the preset condition are extracted respectively. For example, the values of the attributes such as a merchant title text, a business area, whether group purchase is supported, a price per person, and a merchant score of the search results B, C and D are extracted to calculate the similarities S_{bc} and S_{bd}.

At sub-block S12, for each context page element satisfying the preset condition, a single dimension similarity distance between the page element recorded in the exposure log and the context page element is calculated respectively according to a preset similarity calculation model based on each preset dimension attribute value.

For each context result satisfying the preset condition, a single dimension similarity distance between the search result recorded in the exposure log and the context result is calculated respectively according to a preset similarity calculation model based on each preset dimension attribute value. For example, for the search results B and C, the Euclidean distance between B and C in the merchant score dimension may be firstly calculated. For example, in the merchant score dimension, if the merchant scores of the search results B and C recorded in the logs are Score_{b} and Score_{c} respectively, the Euclidean distance between B and C in this dimension is S_{bc1}=|Score_{b}−Score_{c}|. Then; the Euclidean distance of merchant scores, such as S_{bd1} and S_{ab1}, for every pair of results of all context results satisfying the preset condition in the same dimension (for example, in the merchant score dimension) may be calculated respectively. To increase the accuracy of calculation, after the Euclidean distances of merchant scores for all pairs of results are obtained, the Euclidean distances may be normalized, and the normalized distance is denoted by Dₙ. Common normalization methods include a min-max normalization method, a z-score normalization method, and the like. A process of normalizing the Euclidean distance will be described by adopting the min-max normalization method as an example in the present disclosure. A maximum value and a minimum value denoted by Dₘₐₓ and Dₘᵢₙ respectively may be firstly obtained by traversing the Euclidean distances of all pairs of search results in the merchant scores; then, d′ₙ is sequentially obtained by using the following conversion formula

$${D}_{n}^{′} = \frac{{D}_{n} - {D}_{min}}{{D}_{max} - {D}_{min}} ,$$

and this value is the Euclidean distance between two adjacent search results in the merchant score after being normalized by using the min-max normalization method, where Dₙ is an Euclidean distance of a pair of search results.

The Euclidean distances of other dimensions may be obtained respectively by using the same method, and then normalized. Normalization is not needed in the case that some dimension attribute values are either 0 or 1. For example, in the dimension that whether the group purchase is supported, the value supporting the group purchase may be denoted as 1, and the value not supporting the group purchase may be denoted as 0. When the results B and C both support the group purchase or both do not support the group purchase, the Euclidean distance between the two results may be 0; when one of the results supports the group purchase and the other does not support the group purchase, the Euclidean distance between the two results in this dimension may be 1.

At sub-block S13: for each context page element satisfying the preset condition, a similarity distance between the page element recorded in the exposure log and the context page element is obtained by performing weighted averaging for the single dimension similarity distances obtained by calculation.

For each context result satisfying the preset condition, the similarity distance between the search result recorded in the exposure log and the context result may be obtained by performing weighted averaging for the single dimension similarity distances obtained by calculation. After the Euclidean distance (i.e., the single dimensional similarity distance) between the search results A and B of each preset dimension is obtained, a weighted arithmetic average of the Euclidean distances of different dimensions may be used as a final similarity distance between A and B. If the Euclidean distance between the results A and B is D_{ab}, the normalized Euclidean distance of the i-th dimension is D′ᵢ, and a corresponding weight is the Euclidean distance between the search results A and B is:

$${D}_{ab} = \frac{{\sum }_{1}^{n} {W}_{i} * {D}_{i}^{′}}{n} ,$$

where n is a number of preset dimensions. The weight for each dimension may be 1 by default, and different weight values may be set for different attributes in combination with service characteristics to increase importance of the dimension in the similarity distance calculation. For example, the weight of the merchant title text dimension is set to 1, and the weight of the merchant score dimension is set to 0.5.

At sub-block S14, a similarity between the page element recorded in the exposure log and the context page element is obtained according to the similarity distance.

Finally, the similarity between the search result recorded in the exposure log and the context result may be obtained according to the similarity distance. The larger the similarity distance of two results is, the smaller the similarity therebetween is; the smaller the similarity distance is, the larger the similarity therebetween is. Therefore, the similarity S_{ab} between the results A and B may be calculated by using a conversion formula

$${S}_{ab} = \frac{1}{{D}_{ab}} .$$

At sub-block S2, a similarity weight between the page element recorded in the exposure log and each context page element satisfying the preset condition is determined respectively.

Further, a mutual impact between two search results is also related to the presenting ilk orders at which the two search results are presented to a user. The closer the presenting orders of two search results are, the larger the mutual impact is. Determining the similarity weight between the page element recorded in the exposure log and each context page element satisfying the preset condition may include: calculating the similarity weight between the page element recorded in the exposure log and each context page element satisfying the preset condition according to a preset inverse proportional function of a difference of the presenting orders of the page elements.

For example, L_{ab} refers to a distance between presenting orders of the search results A and B, and W_{ab} refers to a similarity weight between the search results A and B. W_{ab} and L_{ab} have an inverse proportional relationship, which indicates that the larger L_{ab} is, the smaller W_{ab} is. The inverse proportional function W_{ab}=1/L_{ab} may be used to indicate a relationship of the distance L_{ab} between the presenting orders of the search results A and B and the similarity weight W_{ab} between the search results. The inverse proportional relationship of W_{ab} and L_{ab} may also be indicated by adopting another inverse proportional function, which is not limited herein. The distance L_{ab} between the presenting orders of the search results A and B may be obtained according to a formula L_{ab}=|rankₐ−rank_{b}|, where rankₐ and rank_{b} refer to the presenting orders of A and B respectively. Preferably, the distance L_{ab} between the presenting orders of the search results A and B may be indicated by a Gaussian weighted distance based on the formula

$${L}_{ab} = {e}^{\frac{{( {rank}_{a} - {rank}_{b} )}^{2}}{2 {σ}^{2}}} ,$$

where rankₐ and rank_{b} refer to the presenting orders of A and B respectively, σ² refers to a variance, and the value of σ may be set to a constant greater than 0 in combination with the service features.

At sub-block S3, a similarity impact value of the exposure log is calculated according to the determined similarity and the corresponding similarity weight.

Calculating the similarity impact value of the exposure log according to each determined similarity and the corresponding similarity weight may include: performing weighted summation for all determined similarities by taking the similarity weight corresponding to each of the similarities as a weight value, and taking an obtained sum as the similarity impact value of the exposure log.

The mutual impact level between the search results A and B are mainly determined by the similarity S_{ab} between the search results A and B, and also relates to the distance between the presenting orders of the search results A and B. When the distance between the presenting orders is smaller, the two search results are more adjacent, and the mutual impact level is larger. In a specific implementation, the similarity impact value between the search results A and B is denoted as MI_{ab} and may be expressed as MI_{ab}=W_{ab}×S_{ab}, where S_{ab} refers to a similarity between the search results A and B, and W_{ab} refers to a similarity weight between the search results A and B.

Similarity impact values between the search result A and other context results (such as B and C) of the search result A satisfying the preset condition may be calculated by adopting the same method, and then accumulated to obtain a total similarity impact value that the search result A is affected by the context results (such as B and C). The similarity impact value of the search result A may be calculated based on a formula

$${TI}_{a} = {\sum }_{y ∈ m}^{ } {MI}_{ay} ,$$

where “m” refers to a set of context results of the search result A satisfying the preset condition, and MI_{ay} refers to a similarity between the search results A and y.

The similarity impact values of the obtained search results recorded in all exposure logs may be calculated respectively by adopting the above method. Then, each of the similarity impact values is normalized. In the present disclosure, a process of normalizing a similarity impact value TI in the solution will be described by adopting the min-max normalization method as an example.

Firstly, a maximum value TIₘₐₓ and a minimum value TIₘᵢₙ may be obtained by traversing all TIs in the logs. If a click-through rate estimation model is trained with data of one week, it is desired to traverse the TIs of all exposure logs in this week to obtain the maximum TI and the minimum TI; if the click-through rate estimation model is trained with data of two weeks or another time period, it is desired to traverse the TIs of the exposure logs in the corresponding time period to obtain the maximum TI and the minimum TI. After TIₘₐₓ and TIₘᵢₙ are obtained, the similarity impact value of each exposure log is normalized. For example, TI′ is sequentially obtained by using a conversion formula TI′=(TI−TIₘᵢₙ)/(TIₘₐₓ−TIₘᵢₙ), where TI′ is the similarity impact value of the search result recorded in the exposure log which has been normalized by using the min-max normalization method.

At block 220, an exposure weight of the exposure log is set according to the normalized similarity impact value and the click label of the exposure log.

Setting the exposure weight of the exposure log according to the normalized similarity impact value and the click label of the exposure log may include: if the click label of the exposure log indicates that a page element recorded in the exposure log is clicked by a user, setting the exposure weight of the exposure log to a first weight; if the click label of the exposure log indicates that a page element recorded in the exposure log is not clicked by the user, setting the exposure weight of the exposure log to a second weight, where the second weight is a value obtained by subtracting a product of the normalized similarity impact value and a preset correction value from the first weight. Each of the exposure logs may refer to a search result presented to the user. The exposure log is set with the click label to mark whether the search result is clicked by the user. If the search result is clicked by the user, the click label of the exposure log of the search result may be set to 1; if the search result is not clicked by the user, the click label of the exposure log of the search result may be set to 0. Whether the search result recorded in each exposure log is clicked by the user may be determined by determining the click label of the exposure log. For example, when a click label of an exposure log A is 1, it may be considered that A is the search result clicked by the user, and thus the exposure weight of A may be set to the first weight, for example, 1; when a click label of an exposure log B is 0, it may be considered that B is the search result not clicked by the user, and thus the exposure weight of B may be set to the second weight, for example, 1−α TI′, where TI′ is the normalized similarity impact value of the exposure log B and may be used to indicate an impact level at which the search result corresponding to the exposure log B is affected by at least one search result adjacent to the search result, and α refers to a preset correction value.

The similarity impact value may be fine-adjusted through the preset correction value α.

In an example, several different α values may be preset, so that several groups of different exposure weight values may be obtained based on the different α values.

After the exposure weights of the exposure logs are set, the click-through rate estimation may be further performed according to the exposure logs set with the exposure weights. In this example, performing the click-through rate estimation according to the exposure logs set with the exposure weights may include: generating one piece of training data respectively based on the click label and the exposure weight of each exposure log and the data feature extracted from the exposure log; training a click-through rate estimation model based on a plurality of pieces of generated training data; and performing the click-through rate estimation through the click-through rate estimation model.

One group of training data may be obtained for each a value, and thus a plurality of groups of training data can be obtained. The click-through rate estimation model may be trained based on each group of training data.

At block 230, one piece of training data is generated based on the click label and the exposure weight of each exposure log and the data feature extracted from the exposure log.

The exposure log may include an exposure log with a click label being 1 (i.e., a log recording a search result clicked by the user) and an exposure log with a click label being 0 (i.e., a log recording a search result not clicked by the user). Generating one piece of training data based on the click label and the exposure weight of each exposure log and the data feature extracted from the exposure log may include: generating, for each exposure log, training data corresponding to the exposure log in combination with the data feature extracted from the exposure log by taking the click label and the exposure weight of the exposure log as a weight field.

A feature field for training the click-through rate estimation model may be formed by extracting a data feature affecting whether a user clicks a search result or not from an exposure log of each search. The extracted data feature mainly includes the following dimensions: a search result material dimension, a user dimension, a time or date dimension, and the like. The search result material dimension may be different depending on different search contents. For example, in a search of food group purchase, the material is a merchant, and the feature of the dimension includes a visit number, a sales volume, a merchant score, consumption per person, a matching degree of a merchant and a user search word, and the like in a past period of time. The user dimension may refer to, for example, a user occupation, a gender, preference of a consumption price, preference of a consumption place/business area/category, and the like. Other dimensions include: time and date at which an exposure log is generated, and the like.

The feature data extracted from the exposure logs may be different due to different service requirements and different search contents, which is not limited herein.

Then, when one piece of training data is constructed by the data feature extracted from each exposure log, the click label of the exposure log and the exposure weight of the exposure log in a specific implementation, each piece of training data may be divided into two fields: a weight field and a data feature field, as shown in Table 1. The weight field includes a click label and an exposure weight; the data feature field includes a plurality of groups of data features, where each group of data feature includes a data feature number and a feature value.

TABLE 1
Training data table

| Weight | |
|---|---|
| held | Data -feature field |
| 0: 0.88 | 1: 6.000000 2: 148.000000 3: 72.000000 4: 35.000000 |
| 1: 1.0 | 1: 1.000000 2: 85.000000 3: 66.000000 4: 29.000000 |

In Table 1, the first column is the weight field including a click label and an exposure weight. In the first column of the first piece of training data, 0 is a click label indicating that the exposure log is not clicked by the user, and 0.88 indicates the exposure weight of the exposure log; in the first column of the second piece of training data, 1 is a click label indicating that the exposure log is clicked by the user, and 1.0 indicates the exposure weight of the exposure log. The second column is a data feature field, as shown in Table 1, the data feature extracted from the exposure log includes four groups numbered 1, 2, 3, and 4 respectively and the data features with different numbers correspond to different feature values.

It may be seen from Table 1 that the exposure weight of the training data with the click label being 0 is less than the exposure weight of the training data with the click label being 1, that is, in the exposure logs, the exposure log clicked by the user has a larger weight when the click-through rate estimation model is trained.

A training data set for training the click-through rate estimation model is formed by a plurality of pieces of training data obtained according to a historical search record.

At block 240, the click-through rate estimation model is trained based on the generated plurality of pieces of training data.

The click-through rate estimation model may be trained by adopting a svm model or a gbdt model based on the training data obtained at the above block. The click-through rate estimation model may be directly trained out by taking the training data as input data of the svm model or the gbdt model and adopting a corresponding model generation method.

In an example, the obtained training data may be divided into two parts. One part is used as model training data for training the click-through rate estimation model, and the other part is used as test data for verifying the click-through rate estimation model obtained by training, or adjusting the parameter of the click-through rate estimation model obtained by training.

In another example, if a plurality of different correction values α are preset, the click-through rate estimation model may be trained according to the obtained plurality of groups of training data. A plurality of click-through rate estimation models obtained by training may be verified by the test data, and a model with the most accurate prediction result may be selected as the click-through rate estimation model used in a search.

The solution of training the click-through rate estimation model based on the training data will not be described herein.

At block 250, the click-through rate estimation is performed through the click-through rate estimation model.

After the click-through rate estimation model is obtained by training, the click-through rate of the search results to be ranked may be estimated by inputting the search results into the click-through rate estimation model.

According to the method of estimating a click-through rate provided in an example of the present disclosure, the click labels may be set for the exposure logs according to the click logs; the similarity impact values of the exposure logs may be determined respectively; the exposure weight of the exposure log may be set according to the normalized similarity impact value and the click label of the exposure log; one piece of training data may be generated respectively based on the click label and the exposure weight of each exposure log and the data feature extracted from the exposure log; the click-through rate estimation model may be trained based on the generated plurality of pieces of training data; finally, the click-through rate estimation may be performed through the click-through rate estimation model. According to the method of estimating a click-through rate, taking an impact of adjacent page elements on an exposure effect in consideration, the exposure weight of the exposure log is set based on the click label of the exposure log and the context similarity of the recorded page element, and then, the exposure weight is introduced when the click-through rate is estimated, so that the estimated click-through rate is more accurate.

### Example 3

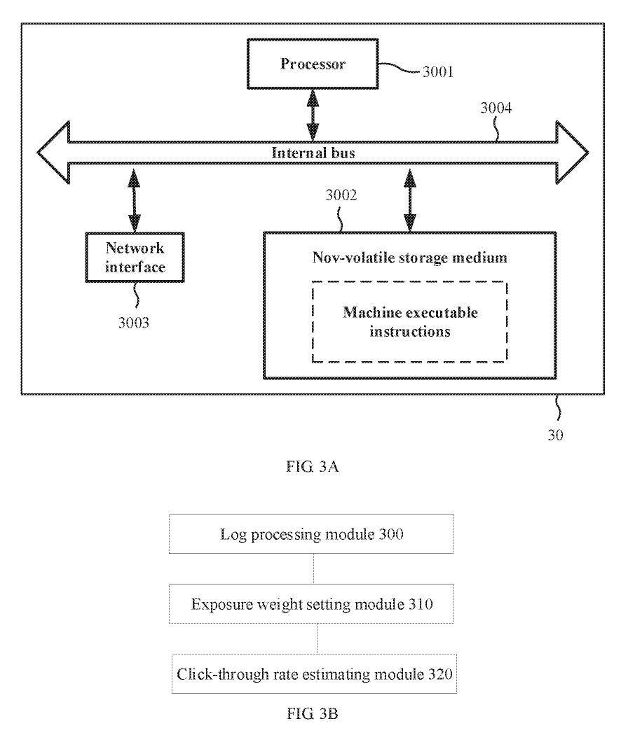

Correspondingly, as shown in FIG. 3A, an example of the present disclosure provides an apparatus 30 for estimating a click-through rate, including: a processor 3001, a non-volatile storage medium 3002, a network interface 3003 and an internal bus 3004, where the processor 3001, the non-volatile storage medium 3002 and the network interface 3003 may communicate with each other via the internal bus 3004. By reading and executing machine executable instructions on the non-volatile storage medium 3002, the processor 3001 may implement the method of estimating a click-through rate described in the present disclosure. FIG. 3B is a schematic diagram illustrating a logic structure of the apparatus 30 for estimating a click-through rate, and functions of the apparatus 30 for estimating a click-through rate may be logically implemented through the following modules, including:
a log processing module 300, configured to set a click label for an exposure log according to a click log, where the exposure log records information of a page element presented to a user;
an exposure weight setting module 310, configured to set an exposure weight corresponding to the exposure log based on the click label of the exposure log and a context similarity of the page element; and
a click-through rate estimating module 320, configured to perform click-through rate estimation based on the exposure log set with the exposure weight.

The apparatus for estimating a click-through rate provided in the example of the present disclosure may set a click label for an exposure log according to a click log, where the exposure log records information of a page element presented to a user; the apparatus may set an exposure weight corresponding to the exposure log based on the click label of the exposure log and a context similarity of the page element; the apparatus may perform click-through rate estimation according to the exposure log set with the exposure weight. The apparatus for estimating a click-through rate considers an impact of adjacent page elements on an exposure effect, sets the exposure weight corresponding to the exposure log based on the click label of the exposure log and the context similarity of the page element, and then, introduces the exposure weight when estimating the click-through rate, thereby enabling the estimated click-through rate to be more accurate.

### Example 4

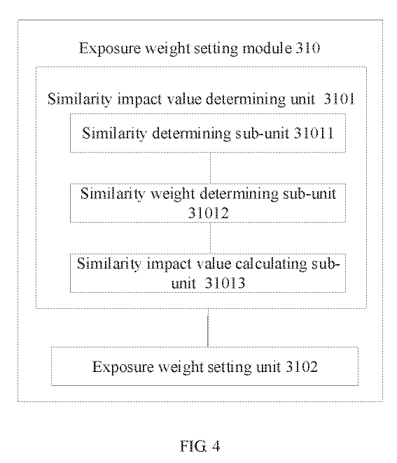

Based on Example 3, Example 4 of the present disclosure provides an apparatus for estimating a click-through rate. As shown in FIG. 4, differences from FIG. 3B will be mainly described herein.

The exposure weight setting module 310 includes:
a similarity impact value determining unit 3101, configured to determine a similarity impact value of the exposure log; and
an exposure weight setting unit 3102, configured to set an exposure weight of the exposure log according to the similarity impact value being normalized and the click label,
wherein, the similarity impact value is used to indicate an impact level at which a page element recorded in the exposure log is affected by a context page element satisfying a preset condition.

In an example, as shown in FIG. 4, the similarity impact value determining unit 3101 includes:
a similarity determining sub-unit 31011, configured to determine a similarity between the page element recorded in the exposure log and each context page element satisfying the preset condition respectively;
a similarity weight determining sub-unit 31012, configured to determine a weight of the similarity between the page element recorded in the exposure log and each context page element satisfying the preset condition respectively; and
a similarity impact value calculating sub-unit 31013, configured to calculate a similarity impact value of the exposure log according to the determined similarity and a corresponding similarity weight.

In another example, the similarity determining sub-unit 31011 is configured to:
determine preset dimension attribute values of the page element recorded in the exposure log and each context page element satisfying the preset condition respectively;
calculate, for each context page element satisfying the preset condition, a single dimension similarity distance between the page element recorded in the exposure log and the context page element respectively based on each preset dimension attribute value according to a preset similarity calculation model;
obtain, for each context page element satisfying the preset condition, a similarity distance between the page element recorded in the exposure log and the context page element by performing weighted averaging for the single dimension similarity distances obtained by calculation; and
obtain the similarity between the page element recorded in the exposure log and the context page element according to the similarity distance.

In another example, the similarity weight determining sub-unit 31012 is configured to:
calculate a similarity weight between the page element recorded in the exposure log and each context page element satisfying the preset condition according to a preset inverse proportional function of a difference of presenting orders of the page elements.

In another example, the similarity impact value calculating sub-unit 31013 is configured to:
perform weighted summation for the determined similarities by taking the similarity weight corresponding to each of the similarities as a weight value, and take a swan obtained by the weighted summation as the similarity impact value of the exposure log.

In another example, the context page element satisfying the preset condition includes: a page element having a difference of the presenting order of the page element and that of the page element recorded in the exposure log being less than a preset order; or a page element having a difference of the presenting order of the page element and that of the page element recorded in the exposure log being less than the preset order and having a same category attribute as the page element recorded in the exposure log.

In another example, the exposure weight setting unit 3102 is configured to:
set the exposure weight of the exposure log to a first weight if the click label of the exposure log indicates that the page element recorded in the exposure log is clicked by a user; and
set the exposure weight of the exposure log to a second weight if the click label of the exposure log indicates that the page element recorded in the exposure log is not clicked by a user,
the second weight is a value obtained by subtracting a product of the similarity impact value being normalized and a preset correction value from the first weight.

The apparatus for generating a click-through rate estimation model provided in the example of the present disclosure may set a click label for an exposure log according to a click log, where the exposure log records information of a page element presented to a user; the apparatus may set an exposure weight corresponding to the exposure log based on the click label of the exposure log and a context similarity of the page element; the apparatus may perform click-through rate estimation according to the exposure log set with the exposure weight. The apparatus for generating a click-through rate estimation model considers an impact of adjacent page elements on an exposure effect when performing click-through rate estimation, sets the exposure weight corresponding to the exposure log based on the click label of the exposure log and the context similarity of the page element, and then, introduces the exposure weight when estimating the click-through rate, thereby enabling the estimated click-through rate to be more accurate.

Correspondingly, the present disclosure also provides an electronic device, including a non-volatile storage medium, a processor and machine executable instructions that are stored on the non-volatile storage medium and operable on the processor. When executing the machine executable instructions, the processor implements the method of estimating a click-through rate in Examples 1 and 2 of present disclosure. The electronic device may be a personal computer (PC), a mobile terminal, a personal digital assistant, a tablet computer, and the like.

The present disclosure also provides a non-volatile storage medium storing instructions. The instructions are executed by one or more processors to implement blocks in the method of estimating a click-through rate described in Examples 1 and 2 of the present disclosure.

Each example in the present disclosure is described in a progressive manner, each example focuses on differences from other examples, and same or similar parts among the examples may be referred to each other. Since an apparatus example is basically similar to a method example, the description is made simply, and a reference may be made to part of the description of the method example for relevant parts.

The above are detailed descriptions of a method and an apparatus for estimating a click-through rate provided by present disclosure. Specific examples are used herein to set forth the principles and examples of the present disclosure, and the descriptions of the above examples are only meant to help understanding of the method and the core idea of the present disclosure. Meanwhile, those of ordinary skill in the art may make alterations to the specific examples and the scope of application in accordance with the idea of the present disclosure. In conclusion, the contents of the present disclosure shall not be interpreted as limiting to the present disclosure.

After reading the descriptions of the above examples, the persons skilled in the art shall understand that each example may be implemented by means of software plus a necessary universal hardware platform, or may also be implemented by hardware. Based on such understanding, the above technical solution of the present disclosure essentially or a part contributing to the prior art may be embodied in a form of a software product, and the computer software product may be stored in a computer readable storage medium, such as a read-only memory or random access memory (ROM/RAM), a magnetic disk, and an optical disk; and the above storage mediums include several instructions for causing a computer device (such as a personal computer, a server, or a network device, or the like) to execute the method described in each example or some parts of the example.

1. A method of estimating a click-through rate, comprising:
setting a click label for an exposure log according to a click log, wherein the exposure log records information of a page element presented to a user;
setting an exposure weight corresponding to the exposure log based on the click label of the exposure log and a context similarity of the page element; and
performing click-through rate estimation based on the exposure log set with the exposure weight.

2. The method according to claim 1, wherein setting the exposure weight corresponding to the exposure log based on the click label of the exposure log and the context similarity of the page element, comprises:
determining a similarity impact value of the exposure log; and
setting an exposure weight of the exposure log according to the similarity impact value being normalized and the click label,
wherein, the similarity impact value is used to indicate an impact level at which a page element recorded in the exposure log is affected by a context page element satisfying a preset condition.

3. The method according to claim 2, wherein determining the similarity impact value of the exposure log, comprises:
determining a similarity between the page element recorded in the exposure log and each context page element satisfying the preset condition and a corresponding similarity weight, respectively; and
calculating the similarity impact value of the exposure log according to the determined similarity and the corresponding similarity weight.

4. The method according to claim 3, wherein determining the similarity between the page element recorded in the exposure log and each context page element satisfying the preset condition, comprises:
determining preset dimension attribute values of the page element recorded in the exposure log and each context page element satisfying the preset condition respectively;
calculating, for each context page element satisfying the preset condition, a single dimension similarity distance between the page element recorded in the exposure log and the context page element respectively based on each preset dimension attribute value according to a preset similarity calculation model;
obtaining, for each context page element satisfying the preset condition, a similarity distance between the page element recorded in the exposure log and the context page element by performing weighted averaging for the single dimension similarity distances obtained by calculation; and
obtaining the similarity between the page element recorded in the exposure log and the context page element according to the similarity distance.

5. The method according to claim 3, wherein determining the similarity weight between the page element recorded in the exposure log and each context page element satisfying the preset condition, comprises:
calculating the similarity weight between the page element recorded in the exposure log and each context page element satisfying the preset condition according to a preset inverse proportional function of a difference of presenting orders of page elements.

6. The method according to claim 3, wherein calculating the similarity impact value of the exposure log according to the determined similarity and the corresponding similarity weight, comprises:
performing weighted summation for the determined similarities by taking the similarity weight corresponding to each of the similarities as a weight value, and
taking a sum obtained by the weighted summation as the similarity impact value of the exposure log.

7. The method according to claim 2, wherein the context page element satisfying the preset condition comprises:
a page element having a presenting order which has a difference being less than a preset order from a presenting order of the page element recorded in the exposure log; or
a page element having a presenting order which has a difference being less than the preset order from the presenting order of the page element recorded in the exposure log, and having a same category attribute as the page element recorded in the exposure log.

8. The method according to claim 2, wherein setting the exposure weight of the exposure log according to the similarity impact value being normalized and the click label, comprises:
when the click label of the exposure log indicates that the page element recorded in the exposure log is clicked by the user, setting the exposure weight of the exposure log to a first weight; and
when the click label of the exposure log indicates that the page element recorded in the exposure log is not clicked by the user, setting the exposure weight of the exposure log to a second weight,
wherein, the second weight is a value obtained by subtracting a product of the similarity impact value being normalized and a preset correction value from the first weight.

9. An apparatus for estimating a click-through rate, comprising:
a processor; and
a non-volatile storage medium storing machine executable instructions, wherein,
by reading and executing the machine executable instructions, the processor is caused to:
set a click label for an exposure log according to a click log, wherein the exposure log records information of a page element presented to a user;
set an exposure weight corresponding to the exposure log based on the click label of the exposure log and a context similarity of the page element; and
perform click-through rate estimation based on the exposure log set with the exposure weight.

10. The apparatus according to claim 9, wherein when the exposure weight corresponding to the exposure log is set based on the click label of the exposure log and the context similarity of the page element, the machine executable instructions also cause the processor to:
determine a similarity impact value of the exposure log; and
set an exposure weight of the exposure log according to the similarity impact value being normalized and the click label,
wherein, the similarity impact value is used to indicate an impact level at which a page element recorded in the exposure log is affected by a context page element satisfying a preset condition.

11. The apparatus according to claim 10, wherein when the similarity impact value of the exposure log is determined, the machine executable instructions also cause the processor to:
determine a similarity between the page element recorded in the exposure log and each context page element satisfying the preset condition respectively;
determine a similarity weight between the page element recorded in the exposure log and each context page element satisfying the preset condition respectively; and
calculate the similarity impact value of the exposure log according to the determined similarity and the corresponding similarity weight.

12. The apparatus according to claim 11, wherein when the similarity between the page element recorded in the exposure log and each context page element satisfying the preset condition is determined, the machine executable instructions also cause the processor to:
determine preset dimension attribute values of the page element recorded in the exposure log and each context page element satisfying the preset condition respectively;
calculate, for each context page element satisfying the preset condition, a single dimension similarity distance between the page element recorded in the exposure log and the context page element respectively based on each preset dimension attribute value according to a preset similarity calculation model;
obtain, for each context page element satisfying the preset condition, a similarity distance between the page element recorded in the exposure log and the context page element by performing weighted averaging for the single dimension similarity distances obtained by calculation; and
obtain the similarity between the page element recorded in the exposure log and the context page element according to the similarity distance.

13. The apparatus according to claim 11, wherein when the similarity weight between the page element recorded in the exposure log and each context page element satisfying the preset condition is determined, the machine executable instructions also cause the processor to:
calculate the similarity weight between the page element recorded in the exposure log and each context page element satisfying the preset condition according to a preset inverse proportional function of a difference of presenting orders of page elements.

14. The apparatus according to claim 11, wherein when the similarity impact value of the exposure log is calculated according to the determined similarity and the corresponding similarity weight, the machine executable instructions also cause the processor to:
perform weighted summation for the determined similarities by taking the similarity weight corresponding to each of the similarities as a weight value, and
take a sum obtained by the weighted summation as the similarity impact value of the exposure log.

15. The apparatus according to claim 10, wherein the context page element satisfying the preset condition comprises:
a page element having a presenting order which has a difference being less than a preset order from a presenting order of the page element recorded in the exposure log; or
a page element having a presenting order which has a difference being less than the preset order from the presenting order of the page element recorded in the exposure log, and having a same category attribute as the page element recorded in the exposure log.

16. The apparatus according to claim 10, wherein when the exposure weight of the exposure log is set according to the similarity impact value being normalized and the click label, the machine executable instructions also cause the processor to:
when the click label of the exposure log indicates that the page element recorded in the exposure log is clicked by the user, set the exposure weight of the exposure log to a first weight; and
when the click label of the exposure log indicates that the page element recorded in the exposure log is not clicked by the user; set the exposure weight of the exposure log to a second weight,
wherein, the second weight is a value obtained by subtracting a product of the similarity impact value being normalized and a preset correction value from the first weight.

17. A non-transitory storage medium storing instructions executable by one or more processors, wherein the instructions are executed by the one or more processors to implement the following operations:
setting a click label for an exposure log according to a click log, wherein the exposure log records information of a page element presented to a user;
setting an exposure weight corresponding to the exposure log based on the click label of the exposure log and a context similarity of the page element; and
performing click-through rate estimation based on the exposure log set with the exposure weight.

18. The non-transitory storage medium according to claim 17, wherein setting the exposure weight corresponding to the exposure log based on the click label of the exposure log and the context similarity of the page element, comprises:
determining a similarity impact value of the exposure log;
setting an exposure weight of the exposure log according to the similarity impact value being normalized and the click label,
wherein, the similarity impact value is used to indicate an impact level at which a page element recorded in the exposure log is affected by a context page element satisfying a preset condition.

19. The non-transitory storage medium according to claim 18, wherein determining the similarity impact value of the exposure log, comprises:
determining a similarity between the page element recorded in the exposure log and each context page element satisfying the preset condition and a corresponding similarity weight, respectively; and
calculating the similarity impact value of the exposure log according to the determined similarity and the corresponding similarity weight.

20. The non-transitory storage medium according to claim 19, wherein determining the similarity between the page element recorded in the exposure log and each context page element satisfying the preset condition and a corresponding similarity weight respectively comprises:
determining preset dimension attribute values of the page element recorded in the exposure log and each context page element satisfying the preset condition respectively;
calculating, for each context page element satisfying the preset condition, a single dimension similarity distance between the page element recorded in the exposure log and the context page element respectively based on each preset dimension attribute value according to a preset similarity calculation model;
obtaining, for each context page element satisfying the preset condition, a similarity distance between the page element recorded in the exposure log and the context page element by performing weighted averaging for the single dimension similarity distances obtained by calculation;
obtaining the similarity between the page element recorded in the exposure log and the context page element according to the similarity distance; and
calculating the similarity weight between the page element recorded in the exposure log and each context page element satisfying the preset condition according to a preset inverse proportional function of a difference of presenting orders of page elements.
